(19) United States
(12) Patent Application Publication
(10) Pub. No.: US 2023/0284121 A1
(43) Pub. Date: Sep. 7, 2023

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Menghan WANG, Shenzhen (CN); Jinguo ZHU, Shenzhen (CN); Shuang LIANG, Shenzhen (CN)

(73) Assignee: ZTE CORPORATION, Shenzhen (CN)

(21) Appl. No.: 18/104,496

(22) Filed: Feb. 1, 2023

Related U.S. Application Data
(63) Continuation of application No. PCT/CN2020/106697, filed on Aug. 4, 2020.

(51) Int. Cl. H04W 48/12; H04L 41/40; H04W 60/00; H04W 36/08

(52) U.S. Cl. CPC H04W 48/12; H04L 41/40; H04W 36/08; H04W 60/00

(57) ABSTRACT

Methods, devices and computer program products for wireless communication are provided. A method includes: receiving, by a communication device, rejection information corresponding to at least one piece of network slice information; and transmitting, by the communication device, a registration request including a requested network slice information, wherein the requested network slice information includes at least one piece of network slice information corresponding to the received rejection information.

This application is a continuation of PCT/CN2020/106697, filed Aug. 4, 2020, the content of which is incorporated herein by reference in its entirety.

### TECHNICAL FIELD

The present disclosure is generally directed to wireless communication. In particular, the present disclosure is directed to methods, devices, and computer program products for wireless communication. In particular the present disclosure relates to 5G wireless communication.

### BACKGROUND

Network slice is a key tool for an operator to provide specific network capabilities and network characteristics for its own service or for third party service. A network slice identified by a single-network slice selection assistance information (S-NSSAI) supports an attribute called “simultaneous use of the network slice”, which describes whether a network slice can be simultaneously used with other network slices. This attribute for example has the following values:
0: Can be used with any network slice
1: Can be used with network slices with same Slice/Service type (SST) value
2: Can be used with network slices with same Slice Differentiator (SD) value
3: Cannot be used with another network slice

The related constraints should be implemented on both user equipment (UE) side and network side. However, it is still an object to determine how to apply the constraints related to simultaneous usage of network slices in the UE and in the network.

### SUMMARY

The present disclosure relates to methods, devices, and computer program products for wireless communication, which can increase the flexibility and efficiency of utilizing network slices, and extend the applicability of network slices.

One aspect of the present disclosure relates to a wireless communication method. In one embodiment, the wireless communication method includes: receiving, by a communication device, rejection information corresponding to at least one piece of network slice information; and transmitting, by the communication device, a registration request comprising a requested network slice information, wherein the requested network slice information comprises the at least one piece of network slice information corresponding to the received rejection information.

Another aspect of the present disclosure relates to a wireless communication method. In one embodiment, the wireless communication method includes: receiving, by a network node from a communication device, a registration request corresponding to at least one piece of requested network slice information; and transmitting, by the network node to the communication device, rejection information corresponding to the at least one piece of network slice information, wherein the rejection information comprises a rejection cause corresponding to slice incompatible information.

Another aspect of the present disclosure relates to a communication device. In one embodiment, the communication device includes a communication unit and a processor. The processor is configured for: receiving, through the communication unit, rejection information corresponding to at least one piece of network slice information; and transmitting, through the communication unit, a registration request including a requested network slice information, wherein the requested network slice information includes the at least one piece of network slice information corresponding to the received rejection information.

Another aspect of the present disclosure relates to a communication device. In one embodiment, the communication device includes a communication unit and a processor. The processor is configured for: receiving, from a communication device through the communication unit, a registration request corresponding to at least one piece of network slice information; and transmitting, through the communication unit, rejection information corresponding to the at least one piece of network slice information to the communication device, wherein the rejection information includes a rejection cause corresponding to slice incompatible information.

Various embodiments may preferably implement the features below.

Preferably in some embodiments, the at least one piece of network slice information includes at least one piece of Single-Network Slice Selection Assistant Information, S-NSSAI.

Preferably in some embodiments, the wireless communication method includes: deriving, by the communication device, at least one piece of requested network slice information for an application based on route selection rules or a local configuration; and determining, by the communication device, whether the at least one piece of requested network slice information matches the at least one piece of network slice information corresponding to the rejection information, wherein the registration request is transmitted in response to the determining result.

Preferably in some embodiments, the rejection information includes a rejection cause, and the registration request is transmitted in response to the rejection cause.

Preferably in some embodiments, the rejection cause includes an indication that the at least one piece of network slice information is not supported within a wireless service area.

Preferably in some embodiments, the wireless communication method includes performing, by the communication device, a cell reselection in response to the rejection cause, to select a cell outside the wireless service area; and transmitting, by the communication device, the registration request via the selected cell.

Preferably in some embodiments, the wireless communication method includes setting, by the communication device, the at least one piece of requested network slice information in a radio access control message, to allow a radio access node to select a destination access management node supporting the at least one piece of requested network slice information.

Preferably in some embodiments, the first wireless service area includes a Registration Area.

Preferably in some embodiments, the rejection cause includes an indication that the at least one piece of network slice information is supported within the current wireless service area and not compatible with an allowed network slice information.

Preferably in some embodiments, the wireless communication method includes setting, by the communication device, the at least one piece of requested network slice information in a radio access control message, to allow a radio access node to select a destination access management node supporting the at least one piece of requested network slice information.

Preferably in some embodiments, the radio access control message does not include at least one piece of information relevant to a destination access management node.

Preferably in some embodiments, the at least one piece of information relevant to a destination access management includes at least one of 5G-S-TMSI (Temporary Mobile Subscriber Identity) and Globally Unique AMF (Access and Mobility Management function) ID, GUAMI.

Preferably in some embodiments, the requested network slice information does not include at least one piece of allowed network slice information.

Preferably in some embodiments, the slice incompatible information includes an indication that the at least one piece of network slice information is not supported within the wireless service area of the communication device.

Preferably in some embodiments, the slice incompatible information includes an indication that the at least one piece of network slice information is not supported within the current Registration Area of the communication device.

Preferably in some embodiments, the slice incompatible information includes an indication that one of the at least one piece of network slice information is supported within the wireless service area of the communication device but is not compatible with an allowed network slice information.

Preferably in some embodiments, the slice incompatible information includes an indication that one of the at least one piece of network slice information is supported within the current Registration Area of the communication device but is not compatible with an allowed network slice information.

Preferably in some embodiments, the registration request includes a piece of Requested Network Slice Selection Assistant Information, NSSAI.

Preferably in some embodiments, the at least one piece of network slice information includes at least one piece of Single-Network Slice Selection Assistant Information, S-NSSAI.

The present disclosure also relates to a computer program product comprising a computer-readable program medium code stored thereupon, the code, when executed by a processor, causing the processor to implement a wireless communication method recited in any of foregoing methods.

### BRIEF DESCRIPTION OF DRAWINGS

FIG. 1 shows a flowchart of a wireless communication method according to an embodiment of the present disclosure;

FIG. 2 shows a flowchart of another wireless communication method according to an embodiment of the present disclosure;

FIG. 3 shows a schematic diagram of a simplified 5G system;

FIG. 4 shows a diagram of a registration procedure;

FIG. 5 shows a diagram of a registration procedure according to one embodiment of the present disclosure;

FIG. 6 shows a diagram of another registration procedure according to one embodiment of the present disclosure;

FIG. 7 shows a diagram of another registration procedure according to one embodiment of the present disclosure;

FIG. 8 shows a schematic diagram of a communication device according to an embodiment of the present disclosure;

FIG. 9 shows a schematic diagram of a network device according to an embodiment of the present disclosure.

### DETAILED DESCRIPTION

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

One aspect of the present disclosure is related to a wireless communication method.

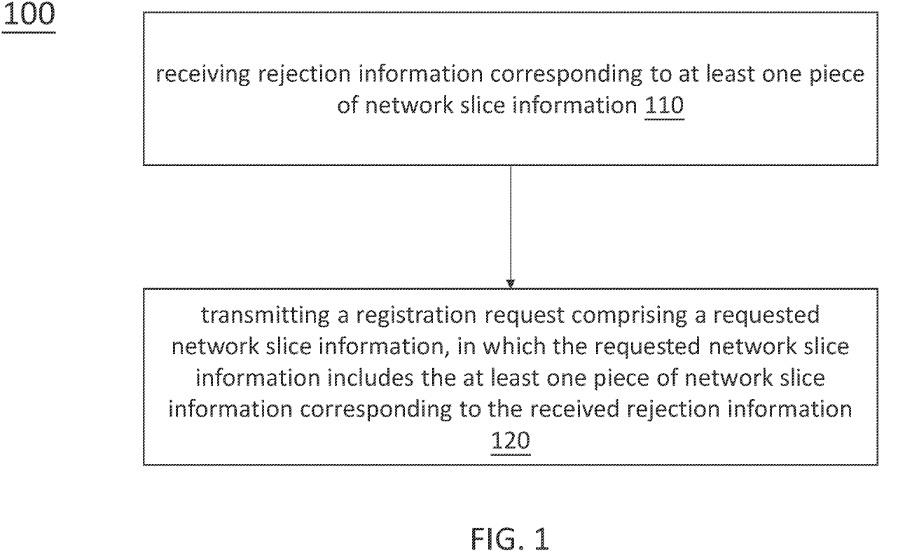

FIG. 1 shows a flowchart of a wireless communication method 100 according to an embodiment of the present disclosure. In one embodiment, the wireless communication method 100 can be performed by using a communication device. In the paragraph below, a communication device will be used in a descriptive example, but the present disclosure is not limited in this regard.

In one embodiment, the wireless communication method 100 includes operations 110 and 120.

In operation 110, the communication device receives rejection information corresponding to at least one piece of network slice information.

In operation 120, the communication device transmits a registration request including a requested network slice information, in which the requested network slice information includes at least one piece of network slice information corresponding to the received rejection information.

Through such operations, a rejected network slice information in the rejection information can be transmitted and requested again, so as to increase the flexibility and efficiency of utilizing network slices, and extends the applicability of network slices.

In some approaches, after a request for a network slice is rejected, a communication device is not allowed to transmit another request for the same network slice again.

On the contrary, in the embodiments of the present disclosure, the communication device can transmit network slice information after it has been rejected. In such a manner, it is possible for the communication device to get the service of the network slice after the reason of rejection is solved.

In one embodiment of the present disclosure, the rejection information includes Network Slice Selection Assistant Information, NSSAI. In one embodiment, the at least one piece of network slice information includes at least one piece of Single-Network Slice Selection Assistant Information, S-NSSAI.

For example, the rejection information may include rejected NSSAI. The rejected NSSAI may include at least one piece of S-NSSAI that are rejected (e.g., rejected S-NSSAI).

In one embodiment of the present disclosure, the requested network slice information may be a requested NSSAI. In one embodiment, the requested NSSAI includes at least one piece of S-NSSAI which is contained by the rejection information (e.g., contained in the rejected NSSAI).

It should be noted that, the specific information (e.g., NSSAI) described above are merely for descriptive purpose, and other information are also possible.

In one embodiment of the present disclosure, the communication device can derive at least one piece of requested network slice information (e.g., at least one piece of derived network slice information) for the application based on route selection rules or a local configuration, and determine whether the derived at least one piece of requested network slice information matches the at least one piece of network slice information corresponding to the rejection information. In one embodiment, the registration request is transmitted in response to this determining result. In one embodiment, the registration request is transmitted when the at least one piece of derived network slice information matches the at least one piece of network slice information corresponding to the rejection information. In one embodiment, the route selection rules can be UE Route Selection Policy (URSP), but is not limited thereto. In one embodiment, the requested network slice information derived by the communication device may be, for example, S-NSSAI.

For example, the communication device may derive a requested S-NSSAI for a specific service of network slice according to URSP or a local configuration when launching an application. Subsequently, the communication device may check whether the requested S-NSSAI matches the network slice information (e.g., the rejected S-NSSAI) corresponding to the rejection information, and accordingly transmit the registration request.

In one embodiment, the communication device may further include operations that the communication device sets the at least one piece of requested network slice information in the registration request.

In one embodiment, the rejection information includes a rejection cause, and the registration request is transmitted in response to the rejection cause. In such a manner, the communication device is able to transmit the registration request in a manner that can avoid the rejection reason for earlier rejection.

In one embodiment, the rejection cause includes an indication that the at least one piece of network slice information is not supported within a wireless service area. In one embodiment, the wireless service area may be the service area(s) of one or more base stations. For example, the wireless service area may include (or may be) a cell, a Tracking Area (TA), a Registration Area (RA), but is not limited in this regard.

In one embodiment, the wireless communication method 100 may further include operations that the communication device performs a cell reselection in response to the rejection cause to select a cell outside the wireless service area and transmits the registration request via the selected cell.

For example, assuming the network slice information corresponding to the rejection information are previously requested via cell #1 in wireless service area A, the communication device would transmit the registration request via the cell #2 outside the wireless service area A.

Through such operations, it can avoid the registration request be transmitted via the same cell and/or the same wireless service area. Accordingly, if the network slice information corresponding to the rejection information is rejected due to the network slice supportability of the cell and/or the wireless service area, the operations above can avoid the registration request being transmitted via the same unsupported cell and/or wireless service area.

In one embodiment, the wireless communication method 100 may further include operations that the communication device sets the at least one piece of requested network slice information in a radio access control message, to allow a radio access node to select a destination access management node supporting the at least one piece of requested network slice information. In one embodiment, the communication device sets the at least one piece of network slice information, which is contained by the at least one piece of requested network slice information, into the radio access control message and the registration request message.

In one embodiment, the radio access control message may be a radio resource control (RRC) message, but is not limited thereto. In one embodiment, the radio access node may be a node in radio access network (RAN), but is not limited thereto. In one embodiment, the access management node may be an Access and Mobility Management Function (AMF) or a device for performing AMF, but is not limited thereto.

Through such operations, it can allow the registration request to be transmitted to an access management node supporting the requested network slice information (e.g., NSSAI) or the network slice information (e.g., S-NSSAI) contained thereto. Accordingly, if the network slice information corresponding to the rejection information is rejected due to the network slice supportability of the processing access management node, the operations above can ensure such a problem would not happen again in the transmission of the registration request.

In one embodiment of the present disclosure, the rejection cause includes an indication that the at least one piece of network slice information is supported within the current wireless service area and not compatible with an allowed network slice information.

For example, the communication device may transmit network slice information A and transmit network slice information B in the same period to request different network slices. In such a condition, the rejection cause may include an indication that network slice information A is allowed and network slice information B is rejected with an indication that network slice information B is not compatible with network slice information A, even though network slice information B is supported by the current wireless service area of the communication device.

With the rejection cause described above, in one embodiment, the wireless communication method 100 may further include operations that the communication device sets the at least one piece of requested network slice information in a radio access control message, to allow a radio access node to select a destination access management node supporting the at least one piece of requested network slice information. In one embodiment, the communication device sets the at least one piece of network slice information, which is contained by the at least one piece of requested network slice information, into the radio access control message and the registration request message.

Through such operations, it can allow the registration request to be transmitted to an access management node supporting the requested network slice information (e.g., NSSAI) or the network slice information (e.g., S-NSSAI) contained thereto. Accordingly, if the network slice information corresponding to the rejection information is rejected due to the network slice supportability of the processing access management node, the operations above can allow the communication device to reach another access management node for requesting service.

In one embodiment, the radio access control message described above does not include at least one piece of information relevant to a destination access management node. In one embodiment, the at least one piece of information relevant to a destination access management includes at least one of 5G-S-TMSI and Globally Unique AMF ID (GUAMI), but is not limited in this regard.

Through such a configuration, it can be avoided the radio access control message being directed to the same access management node that rejects the at least one piece of information corresponding to the rejection information in previous operations.

In one embodiment, the requested network slice information does not include at least one piece of allowed network slice information. For example, in the situation described above, the requested network slice information would contain network slice information B and not contain network slice information A. In such a manner, since network slice information A would not be requested in the request information, the incompatibility problem for network slice information B can be avoided.

Another aspect of the present disclosure is related to another wireless communication method.

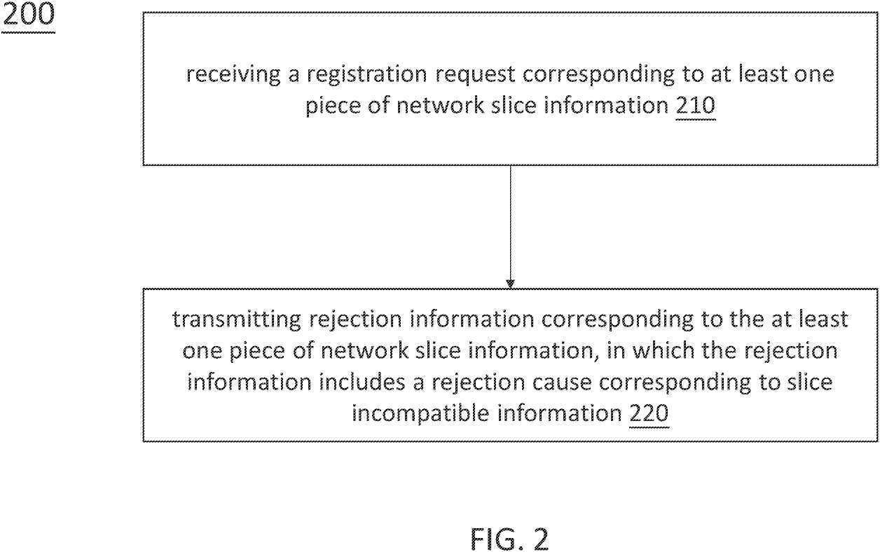

FIG. 2 shows a flowchart of a wireless communication method 200 according to an embodiment of the present disclosure. In one embodiment, the wireless communication method 200 can be performed by using a network node (e.g., a network device). In the paragraph below, a network node will be used in a descriptive example, but the present disclosure is not limited in this regard.

In one embodiment, the wireless communication method 200 includes operations 210 and 220.

In operation 210, the network node receives a registration request corresponding to at least one piece of network slice information. In one embodiment the registration request may be transmitted from a communication device.

It should be noted that, the registration request in operation 210 is different from the registration request in operation 120. In some perspective, the registration request in operation 210 can be regarded as a previous registration request transmitted by the communication device before the communication device receive the rejection information in operation 110.

In operation 220, the network node transmits rejection information corresponding to the at least one piece of network slice information, in which the rejection information includes a rejection cause corresponding to slice incompatible information. In one embodiment the rejection request may be transmitted to the communication device. In some perspective, the rejection information in operation 220 may correspond to the rejection information in operation 110, but is not limited in this regard.

Through such operations, the communication device is able to transmit another registration request containing the network slice information in the rejection information again according to the rejection cause. In this manner, the flexibility and efficiency of utilizing network slices can be increased, and the applicability of network slices can be extended.

In one embodiment, the registration request includes a piece of NSSAI.

In one embodiment, the at least one piece of network slice information includes at least one piece of S-NSSAI.

In one embodiment, the slice incompatible information includes an indication that the at least one piece of network slice information is not supported within the wireless service area of the communication device.

In one embodiment, the slice incompatible information includes an indication that the at least one piece of network slice information is not supported within the current Registration Area of the communication device.

In one embodiment, the slice incompatible information comprises an indication that one of the at least one piece of network slice information is supported within the wireless service area of the communication device but is not compatible with an allowed network slice information.

In one embodiment, the slice incompatible information includes an indication that one of the at least one piece of network slice information is supported within the current Registration Area of the communication device but is not compatible with an allowed network slice information.

Details of these features can be ascertained by referring to the description related to method 100, and will not be described herein.

In the paragraphs below, a 5G system would be taken as an example to facilitate the understanding of embodiments of the present disclosure. However, the present disclosure is not limited to the 5G system.

It should be noted that, the methods 100, 200 described above can respectively include parts of operations in the example below, and the devices performing the methods 100, 200 can perform parts of operations in the example below. For example, the communication device can perform the operations of UE in the example below, and the network node (network device) can perform the operations of network-side devices, such as operations of at least one of AMF, Radio Access Network (RAN), Network Slice Selection Function (NSSF), Unified Data Management (UDM), and Session Management Function (SMF).

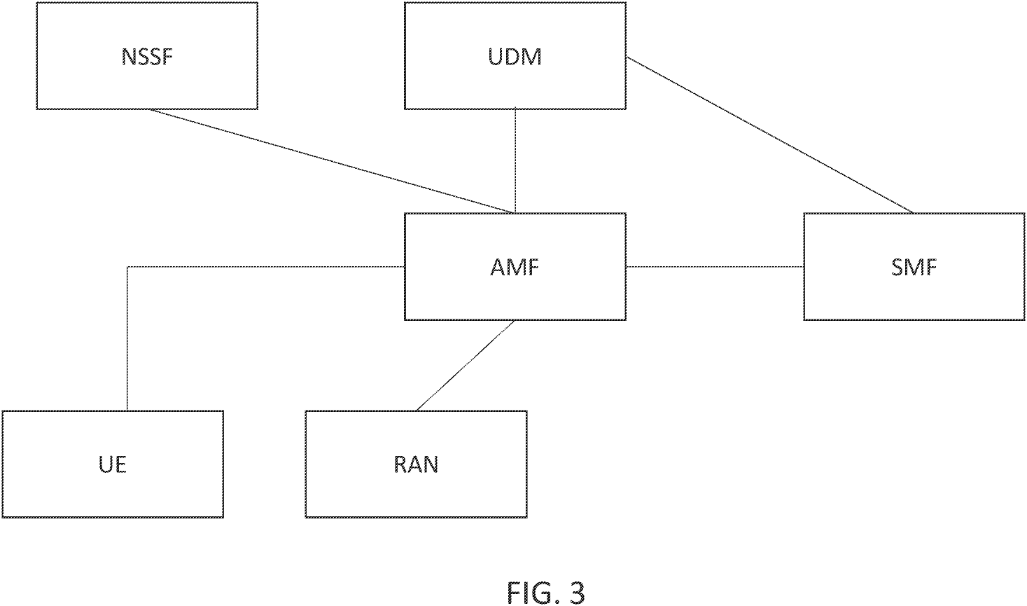

FIG. 3 shows a schematic diagram of a simplified 5G system. The simplified 5G system includes the following network functions (NFs):

UE, User Equipment.

RAN, Radio Access Network.

AMF, Access and Mobility Management Function. This NF includes functionalities such as UE Mobility Management, Reachability Management, Connection Management and Registration Management. The AMF terminates the RAN control plane (CP) interface N2 and NAS interface N1, NAS ciphering and integrity protection. It also distributes the SM NAS to the proper SMFs via N11 interface.

During Registration procedure, the AMF may determine the Allowed NSSAI, the Rejected NSSAI with rejection cause based on the Requested NSSAI received from the UE. The AMF further determines the Registration Area within which the UE can use all S-NSSAIs of the Allowed NSSAI. The AMF sends the Allowed NSSAI, the Rejected NSSAI with rejection cause and the Registration Area to the UE.

NSSF, Network Slice Selection Function. This NF supports the following functionality: selecting the set of network slice instances serving the UE; determining the Allowed NSSAI and, if needed, the mapping to the HPLMN S-NSSAIs; determining the Configured NSSAI and, if needed, the mapping to the HPLMN S-NSSAIs; determining the AMF Set to be used to serve the UE, or, based on configuration, a list of candidate AMF(s), possibly by querying the Network Repository Function (NRF).

UDM, Unified Data Management. This NF manages the subscription profile for the UEs. The subscription data is stored in the Unified Data Repository (UDR). The subscription information includes the data used for Mobility Management and Session Management. The AMF and SMF retrieve the subscription data from the UDM.

SMF, Session Management Function. This NF includes the following functionalities: session establishment, modification and release, UE IP address allocation & management, selection and control of user plane (UP) function, etc.

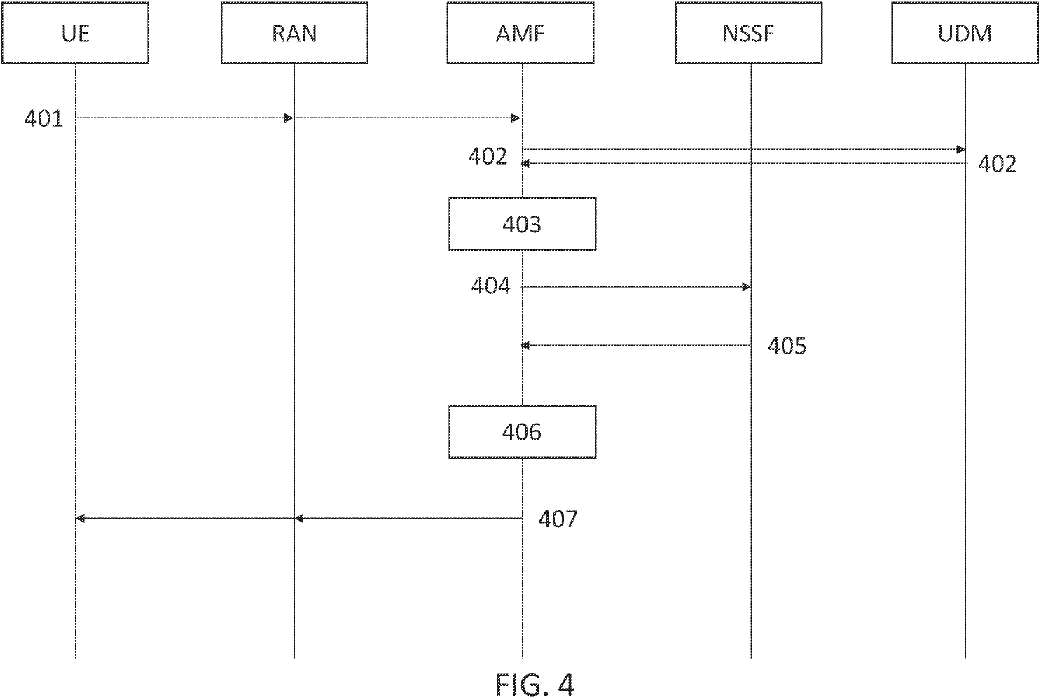

FIG. 4 shows a diagram of registration procedure of a set of network slices.

In operation 401, a UE transmit a registration request including Requested NSSAI. In this operation, when the UE registers over an Access Type with a PLMN, the UE provides to the network in NAS layer, a Requested NSSAI containing the S-NSSAI(s) corresponding to the network slice(s) to which the UE wishes to register. The registration request can be transmitted to a AMF via RAN.

The Requested NSSAI can be one of:

The Default Configured NSSAI, i.e. if the UE has no Configured NSSAI nor an Allowed NSSAI for the serving PLMN.

The Configured-NSSAI, or a subset thereof, e.g. if the UE has no Allowed NSSAI for the Access Type for the serving PLMN.

The Allowed-NSSAI for the Access Type over which the Requested NSSAI is sent, or a subset thereof.

The Allowed-NSSAI for the Access Type over which the Requested NSSAI is sent, or a subset thereof, plus one or more S-NSSAIs from the Configured-NSSAI not yet in the Allowed NSSAI for the Access Type.

In operation 402, when the AMF selected by the RAN during Registration Procedure receives the registration request from the UE, the AMF may query the UDM to retrieve UE subscription information including the Subscribed S-NSSAIs.

In operation 403, the AMF verifies whether the S-NSSAI(s) in the Requested NSSAI are permitted based on the Subscribed S-NSSAIs. To identify the Subscribed S-NSSAIs, the AMF may use the mapped HPLMN S-NSSAIs provided by the UE in the NAS message, for each S-NSSAI of the Requested NSSAI.

In operation 404, when the UE context in the AMF does not include an Allowed NSSAI for the corresponding Access Type, the AMF queries the NSSF for network slice selection. The IP address or FQDN of the NSSF is locally configured in the AMF. It should be noted that, in the case that the AMF is allowed to determine whether it can serve the UE based on configuration in this AMF, the AMF does not have to query the NSSF for network slice selection .

In operation 405, the NSSF returns to the AMF the Allowed NSSAI. It may also return the Rejected S-NSSAI(s) with rejection cause indicating the reason why the S-NSSAI(s) has been rejected.

In operation 406, the serving AMF may determine a Registration Area such that all S-NSSAIs in the Allowed NSSAI are available in all Tracking Areas of the Registration Area.

In operation 407, the AMF sends a Registration Accept message to the UE including the Allowed NSSAI and the mapped HPLMN NSSAI of the Allowed NSSAI if provided, the Rejected S-NSSAI(s) rejection cause and the Registration Area.

After completion of the Registration procedure, the UE may request to establish a PDU Session. The Requested S-NSSAI of the PDU Session is derived from the URSP rules or UE Local Configuration. The Requested S-NSSAI is within the Allowed NSSAI.

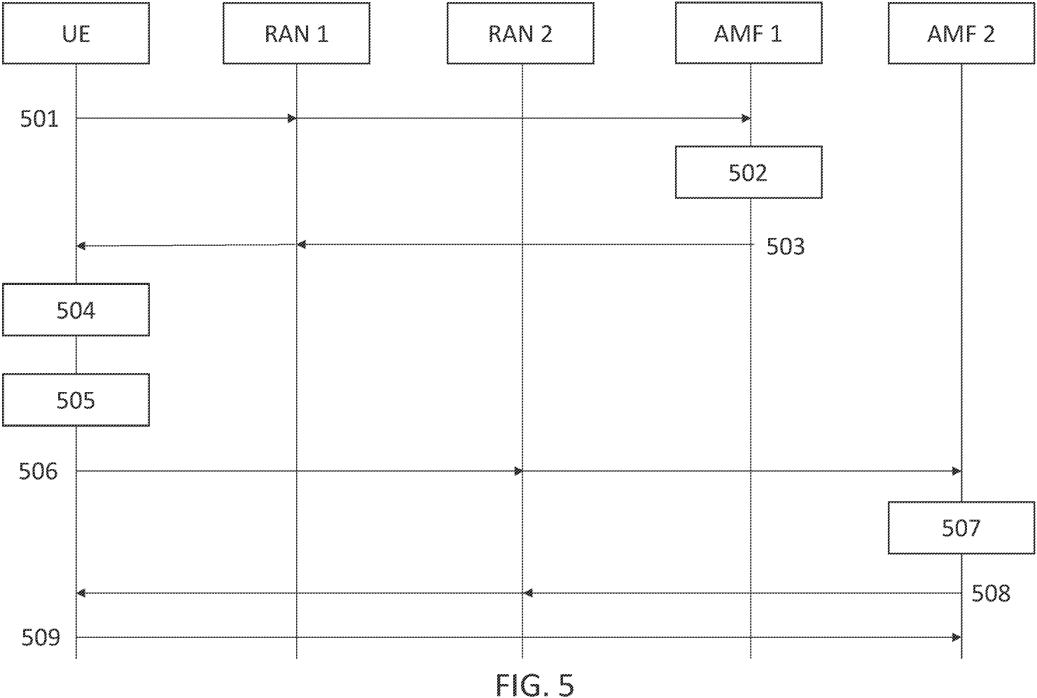

FIG. 5 shows a diagram of a registration procedure according to one embodiment of the present disclosure.

In operation 501, the UE initiates a Registration Procedure with Requested NSSAI via RAN node 1. The UE generates the Requested NSSAI in the NAS message based on the Default Configured NSSAI, the Configured NSSAI for the Serving PLMN, and the Allowed NSSAI if available. The Requested NSSAI may include incompatible S-NSSAIs, e.g. S-NSSAI(s) supported by the current Tracking Area (e.g., S-NSSAI #1) and S-NSSAI(s) (e.g., S-NSSAI #2) not supported by the current Tracking Area.

In roaming scenarios, the UE also provides the mapped HPLMN NSSAI of the Requested NSSAI if the mapping information is stored in the UE.

In operation 502, the AMF (e.g., AMF 1) and/or NSSF performs a network slice selection. The network slice selection can be ascertained by referring to operations 402 to 406. It should be noted that, for clear purpose, NSSF are omitted in FIG. 5.

If the AMF 1 and/or NSSF determines that one or more S-NSSAIs (e.g., S-NSSAI #2) in the Requested NSSAI are not supported by the current Tracking Area, the AMF 1 or NSSF puts the S-NSSAIs in the Rejected NSSAI with rejection cause indicating that the S-NSSAIs are not supported within the current Registration Area. The AMF 1 and/or NSSF may decide the Allowed NSSAI (e.g., containing S-NSSAI #1) which are compatible and can be used in the current Registration Area. The AMF 1 and/or NSSF may also determine the mapped HPLMN NSSAI of the Allowed NSSAI in the roaming case.

In operation 503, the AMF 1 sends a Registration Accept message to the UE and includes the Allowed NSSAI (e.g., containing S-NSSAI #1), the Rejected NSSAI (e.g., containing S-NSSAI #2) and the Registration Area.

In operation 504, when the UE intends to initiate a PDU Session Establishment Procedure, the UE first derives the requested S-NSSAI that matches the application within the NSSP in the URSP rules or within the UE Local Configuration. In roaming case, the S-NSSAI derived from the URSP rules or UE Local Configuration is HPLMN S-NSSAI. The UE determines the mapped VPLMN S-NSSAI of the HPLMN S-NSSAI and set the VPLMN S-NSSAI as the requested S-NSSAI for the PDU Session.

In operation 505, if the new requested S-NSSAI is one S-NSSAI within the Rejected NSSAI and the rejection cause indicating that it is not available in the current Registration Area, and the UE detects that there is other cells of the same PLMN outside of the Registration Area in the current geographical location, then the UE performs cell reselection to select a new cell.

If there are multiple cells outside the Registration Area existing in the UE location that can be detected by the UE, the UE may reselect the other cell one by one until it receives the Allowed NSSAI including the interested requested S-NSSAI.

In operation 506, the UE initiates Mobility Registration Procedure via the selected new cell. The UE may set the Requested NSSAI containing the new requested S-NSSAI in NAS message in the same way as the Mobility Registration Procedure. In another example, the UE may set the Requested NSSAI in the Registration Request message as the S-NSSAI matched with the application and derived from the URSP rules or UE Local Configuration. The UE may set the new requested S-NSSAI matched with the application in the RRC message so a RAN node 2 corresponding to the selected cell can reselect a proper AMF according to the new S-NSSAI to serve the requested S-NSSAI, in which the proper AMF indicates an AMF supports the new S-NSSAI. The Requested NSSAI may contain or not contain S-NSSAI(s) in the Allowed NSSAI.

In roaming scenarios, the UE also provides the mapped HPLMN NSSAI of the Requested NSSAI if the mapping information is stored in the UE.

In operation 507, the new AMF (e.g., AMF 2) and/or corresponding NSSF perform network slice selection. The AMF 2 and/or corresponding NSSF determine the new Allowed NSSAI which includes the Requested NSSAI and the new Registration Area.

If there is/are S-NSSAI(s) associated with the existing PDU session(s) of the UE not included in the requested NSSAI of the REGISTRATION REQUEST message, the AMF 2 may perform a local release of the PDU session(s) associated with the S-NSSAI(s) and may request the SMF to perform a local release of those PDU session(s). For example, if S-NSSAI #1 is not included in the requested NSSAI of the REGISTRATION REQUEST message, the AMF 2 may perform a local release of the PDU session(s) associated with the S-NSSAI #1 and may request the SMF to perform a local release of those PDU session(s).

In operation 508, the AMF 2 sends a Registration Accept message to the UE. This message includes the new Allowed NSSAI which includes the requested NSSAI and the new Registration Area.

In operation 509, after the successful Registration Procedure, the UE initiates a PDU Session Establishment Procedure with the new requested S-NSSAI which is within the Allowed NSSAI through the new RAN node towards the AMF 2.

Subsequently, the PDU Session Establishment Procedure is continuously processed.

Through the operations above, the UE can get the service corresponding to the network slices indicated by S-NSSAI #2.

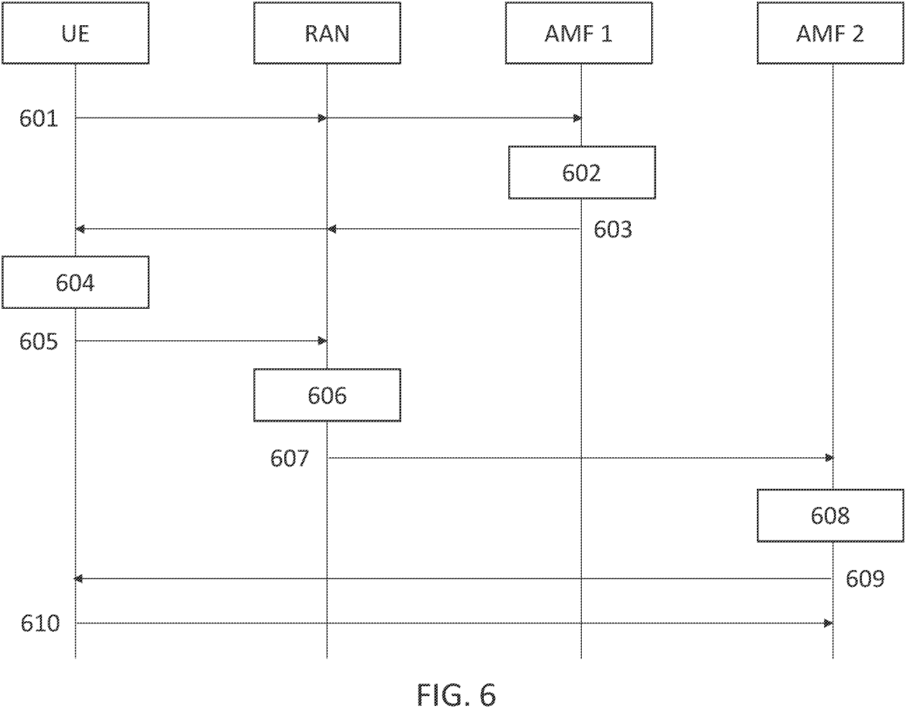

FIG. 6 shows a diagram of a registration procedure according to another embodiment of the present disclosure.

In operation 601, the UE initiates a Registration Procedure with Requested NSSAI. The UE generates the Requested NSSAI in the NAS message based on the Default Configured NSSAI, the Configured NSSAI for the Serving PLMN, and the Allowed NSSAI if available. The Requested NSSAI may include incompatible S-NSSAIs, e.g. S-NSSAI(s) supported by the current Tracking Area and the current AMF (e.g., S-NSSAI #1) and S-NSSAI(s) (e.g., S-NSSAI #2) supported by the current Tracking Area but not supported by the current MAF.

In roaming scenarios, the UE also provides the mapped HPLMN NSSAI of the Requested NSSAI if the mapping information is stored in the UE.

In operation 602, the AMF (e.g., AMF 1) and/or NSSF performs a network slice selection. The network slice selection can be ascertained by referring to operations 402 to 406. It should be noted that, for clear purpose, NSSF are omitted in FIG. 6.

The AMF 1 and/or NSSF determines the Allowed NSSAI (e.g., containing S-NSSAI #1) and the Registration Area. The S-NSSAI(s) in the Allowed NSSAI are compatible and can be used in the current Registration Area. The AMF 1 and/or NSSF may determine based on the configuration that at least one S-NSSAI (e.g., S-NSSAI #2) in the Requested NSSAI is incompatible with the Allowed NSSAI, e.g. this S-NSSAI is not supported by the current AMF, then AMF 1 and/or NSSF puts the S-NSSAI in the rejected NSSAI with a reject cause indicating the S-NSSAI is supported in the Registration Area but is incompatible with the Allowed NSSAI. The AMF 1 and/or NSSF may also determine the mapped HPLMN NSSAI of the Allowed NSSAI in the roaming case.

In operation 603, the AMF 1 sends a Registration Accept message to the UE and includes the Allowed NSSAI (e.g., containing S-NSSAI #1), the Rejected NSSAI (e.g., containing S-NSSAI #2) and the Registration Area.

In operation 604, when the UE intends to initiate a PDU Session Establishment Procedure, the UE first derives the requested S-NSSAI that matches the application within the NSSP in the URSP rules or within the UE Local Configuration. In roaming case, the S-NSSAI derived from the URSP rules or UE Local Configuration is HPLMN S-NSSAI. The UE determines the mapped VPLMN S-NSSAI of the HPLMN S-NSSAI and set the VPLMN S-NSSAI as the requested S-NSSAI for the PDU Session.

In operation 605, if the new requested S-NSSAI is one S-NSSAI within the Rejected NSSAI and the rejection cause indicating that it is supported in the current Registration Area but is incompatible with the Allowed NSSAI, the UE initiates Mobility Registration Procedure.

The UE may not set the 5G-S-TMSI or GUAMI in the RRC message. Besides, the UE may set the new requested S-NSSAI matched with the application in the RRC message so that the RAN node can reselect a new proper AMF to serve the requested S-NSSAI, in which the proper AMF indicates an AMF supports the new S-NSSAI.

The UE may set the Requested NSSAI containing the new requested S-NSSAI in NAS message in the same way as the Mobility Registration Procedure. In another example, the UE may set the Requested NSSAI in the NAS message as the S-NSSAI matched with the application and derived from the URSP rules or UE Location Configuration. The Requested NSSAI may contain or not contain S-NSSAI(s) in the Allowed NSSAI.

In roaming scenarios, the UE also provides Mapping of Requested NSSAI if the mapping information is stored in the UE.

In operation 606, The RAN node performs AMF selection based on the requested S-NSSAI in RRC message. If no requested S-NSSAI is provided by the UE in RRC message, the RAN node selects the default AMF.

In operation 607, the RAN node forwards the NAS Registration Request towards the new selected AMF (e.g., AMF 2) or default AMF. If the RAN node forwards the NAS Registration Request to the default AMF, the default AMF may further redirect the NAS message to target AMF (e.g., AMF 2).

In operation 608, the AMF 2 and/or corresponding NSSF perform network slice selection. The AMF 2 and/or corresponding NSSF determine the new Allowed NSSAI which includes the Requested NSSAI and the new Registration Area.

If there is/are S-NSSAI(s) associated with the existing PDU session(s) of the UE not included in the requested NSSAI of the REGISTRATION REQUEST message, the AMF 2 may perform a local release of the PDU session(s) associated with the S-NSSAI(s) and may request the SMF to perform a local release of those PDU session(s).

In operation 609, the AMF 2 sends a Registration Accept message to the UE. This message includes the new Allowed NSSAI which includes the Requested NSSAI and the new Registration Area.

After the successful Registration Procedure, the UE initiates a PDU Session Establishment Procedure with the new requested S-NSSAI which is within the Allowed NSSAI and the PDU Session Establishment Procedure is executed.

Through the operations above, the UE can get the service corresponding to the network slices indicated by S-NSSAI #2.

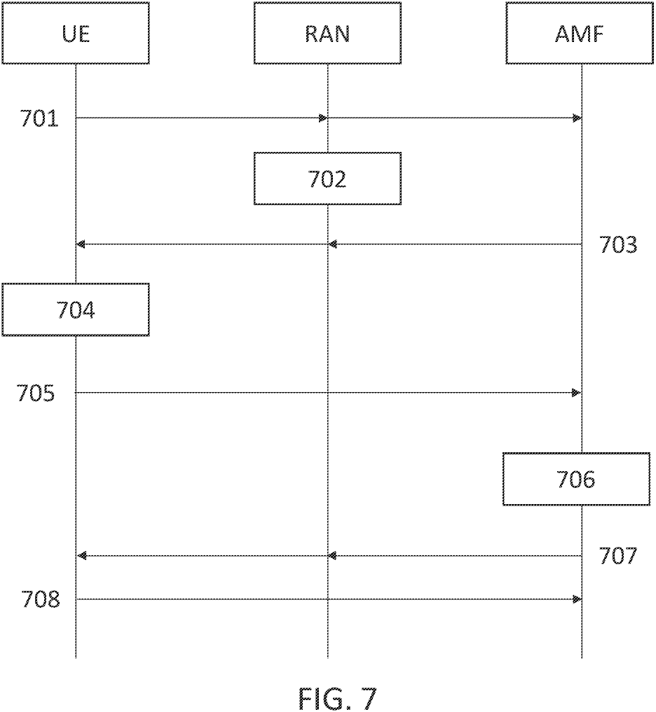

FIG. 7 shows a diagram of a registration procedure according to another embodiment of the present disclosure.

In operation 701, the UE initiates a Registration Procedure with Requested NSSAI. The UE generates the Requested NSSAI in the NAS message based on the Default Configured NSSAI, the Configured NSSAI for the Serving PLMN, and the Allowed NSSAI if available. The Requested NSSAI may include incompatible S-NSSAIs, e.g. S-NSSAIs supported by the current Tracking Area and the current AMF but incompatible based on the configuration.

In roaming scenarios, the UE also provides the mapped HPLMN NSSAI of the Requested NSSAI if the mapping information is stored in the UE.

In operation 702, the AMF and/or NSSF performs a network slice selection. The network slice selection can be ascertained by referring to operations 402 to 406. It should be noted that, for clear purpose, NSSF are omitted in FIG. 7.

The AMF and/or NSSF may be configured via OAM about network slice attribute including the “simultaneous use of the network slice”. The AMF and/or NSSF determines the Allowed NSSAI (e.g., containing S-NSSAI #1) and the Registration Area. The AMF and/or NSSF may determine based on the configuration that one or more S-NSSAIs (e.g., containing S-NSSAI #2) in the Requested NSSAI are incompatible with the Allowed NSSAI, e.g., supported by the current Tracking Area and AMF but incompatible with the Allowed NSSAI based on the configuration, the AMF and/or NSSF puts the one or more S-NSSAIs in the rejected NSSAI with a rejection cause indicating that these S-NSSAIs are supported in the current Registration Area and AMF but not compatible with the Allowed NSSAI, which means that the UE can register with the rejected S-NSSAI within the current Registration Area.

The AMF and/or NSSF may also determine the mapped HPLMN NSSAI of the Allowed NSSAI in the roaming case.

In operation 703, the AMF sends a Registration Accept message to the UE and includes the Allowed NSSAI (e.g., containing S-NSSAI #1), the Rejected NSSAI (e.g., containing S-NSSAI #2) and the Registration Area.

In operation 704, when the UE intends to initiate a PDU Session Establishment Procedure, the UE first derives the requested S-NSSAI that matches the application within the NSSP in the URSP rules or within the UE Local Configuration. In roaming case, the S-NSSAI derived from the URSP rules or UE Local Configuration is HPLMN S-NSSAI. The UE determines the mapped VPLMN S-NSSAI of the HPLMN S-NSSAI and set the VPLMN S-NSSAI as the requested S-NSSAI for the PDU Session.

In operation 705, if the new requested S-NSSAI is one S-NSSAI within the Rejected NSSAI and the rejection cause indicating that it is supported in the current Registration Area but is incompatible with the Allowed NSSAI, then the UE initiates Mobility Registration Procedure.

The UE may set the Requested NSSAI in NAS message in the same way as the Mobility Registration Procedure but exclude the old Allowed NSSAI received from the AMF. For example, the Requested NSSAI may contain S-NSSAI #2 but not contain S-NSSAI #1.

In another example, the UE may set Requested NSSAI in NAS Registration Request message as S-NSSAI matched with the application and derived from the URSP rules or UE Location Configuration.

In another example the UE may not set the 5G-S-TMSI or GUAMI in the RRC message. In another example the UE may set the new requested S-NSSAI matched with the application in the RRC message so the RAN node can reselect a new proper AMF to serve the requested S-NSSAI.

In roaming scenarios, the UE also provides Mapping of Requested NSSAI if the mapping information is stored in the UE.

In operation 706, the AMF and/or NSSF performs network slice selection. The AMF and/or NSSF determines the new Allowed NSSAI which includes the requested S-NSSAI and the new Registration Area.

If there is/are S-NSSAI(s) associated with the existing PDU session(s) of the UE not included in the requested NSSAI of the REGISTRATION REQUEST message, the AMF 2 may perform a local release of the PDU session(s) associated with the S-NSSAI(s) and may request the SMF to perform a local release of those PDU session(s). For example, if S-NSSAI #1 is not included in the requested NSSAI of the REGISTRATION REQUEST message, the AMF 2 may perform a local release of the PDU session(s) associated with the S-NSSAI #1 and may request the SMF to perform a local release of those PDU session(s).

In operation 707, the AMF sends a Registration Accept message to the UE. This message includes the new Allowed NSSAI which includes the requested NSSAI and the new Registration Area.

In operation 708, after the successful Registration Procedure, the UE initiates a PDU Session Establishment Procedure with the new requested S-NSSAI which is within the Allowed NSSAI to the AMF.

Subsequently, the PDU Session Establishment Procedure is continuously processed.

Through the operations above, the UE can get the service corresponding to the network slices indicated by S-NSSAI #2.

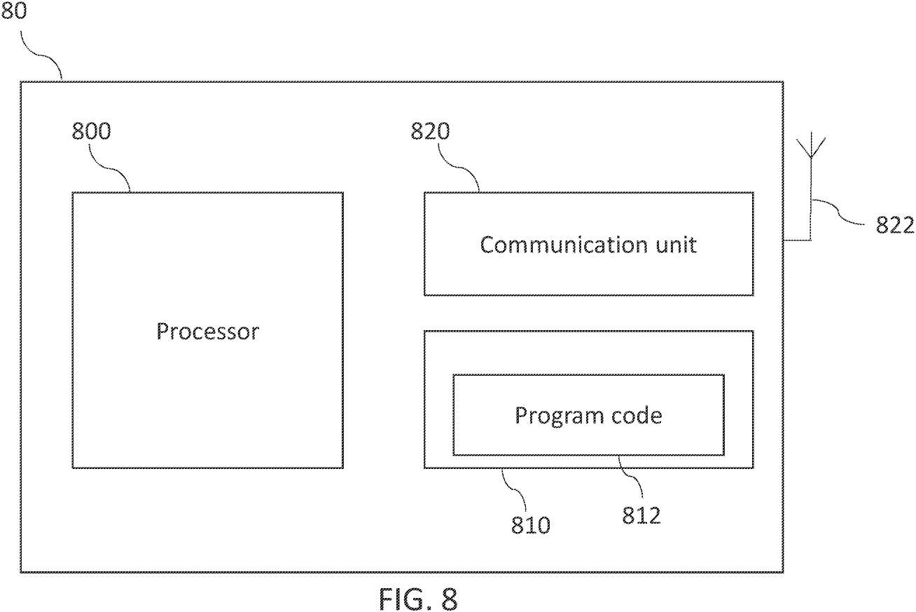

FIG. 8 relates to a schematic diagram of a communication device 80 (e.g., a wireless terminal) according to an embodiment of the present disclosure. The communication device 80 may be a user equipment (UE), a mobile phone, a laptop, a tablet computer, an electronic book or a portable computer system and is not limited herein. The communication device 80 may include a processor 800 such as a microprocessor or Application Specific Integrated Circuit (ASIC), a storage unit 810 and a communication unit 820. The storage unit 810 may be any data storage device that stores a program code 812, which is accessed and executed by the processor 800. Embodiments of the storage unit 810 include but are not limited to a subscriber identity module (SIM), read-only memory (ROM), flash memory, random-access memory (RAM), hard-disk, and optical data storage device. The communication unit 820 may a transceiver and is used to transmit and receive signals (e.g. messages or packets) according to processing results of the processor 800. In an embodiment, the communication unit 820 transmits and receives the signals via at least one antenna 822 shown in FIG. 8.

In an embodiment, the storage unit 810 and the program code 812 may be omitted and the processor 800 may include a storage unit with stored program code.

The processor 800 may implement any one of the steps in exemplified embodiments on the communication device 80, e.g., by executing the program code 812.

The communication unit 820 may be a transceiver. The communication unit 820 may as an alternative or in addition be combining a transmitting unit and a receiving unit configured to transmit and to receive, respectively, signals to and from a network device.

In some embodiments, the communication device 80 can be used to perform the operations described above (e.g., operations in the method 100, and other relevant operations). In some embodiments, the processor 800 and the communication unit 820 collaboratively perform the operations described above. For example, the processor 800 performs operations and transmit or receive signals through the communication unit 820.

In one embodiment, the processor 800 is configured for receiving rejection information corresponding to at least one piece of network slice information through the communication unit 820, and transmitting a registration request including a requested network slice information through the communication unit 820. The requested network slice information includes the at least one piece of network slice information corresponding to the received rejection information.

In one embodiment, the processor 800 is configured for performing a cell reselection in response to the rejection cause to select a cell outside the wireless service area, and transmitting the registration request via the selected cell through the communication unit 820.

In one embodiment, the processor 800 is configured for setting the at least one piece of requested network slice information in a radio access control message, to allow a radio access node to select a destination access management node supporting the at least one piece of requested network slice information.

Details of operations of the communication device 80 can be ascertained with reference to the embodiments above, and will not be described herein.

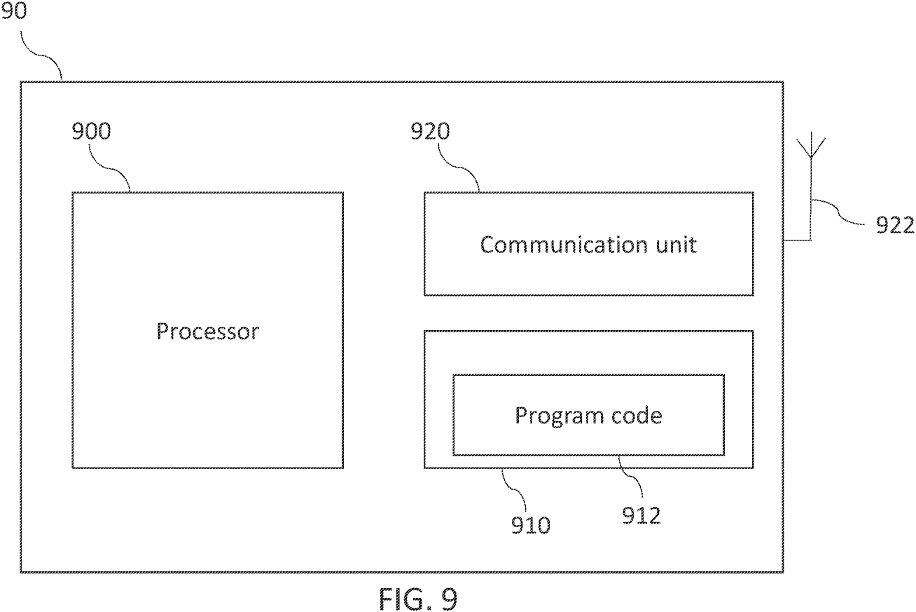

FIG. 9 relates to a schematic diagram of a network device 90 (e.g., a wireless network node) according to an embodiment of the present disclosure. The network device 90 may be a satellite, a base station (BS), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the network device 90 may comprise (perform) at least one network function such as an access and mobility management function (AMF), a session management function (SMF), a user place function (UPF), a policy control function (PCF), an application function (AF), etc. The network device 90 may include a processor 900 such as a microprocessor or ASIC, a storage unit 910 and a communication unit 920. The storage unit 910 may be any data storage device that stores a program code 912, which is accessed and executed by the processor 900. Examples of the storage unit 910 include but are not limited to a SIM, ROM, flash memory, RAM, hard-disk, and optical data storage device. The communication unit 920 may be a transceiver and is used to transmit and receive signals (e.g. messages or packets) according to processing results of the processor 900. In an example, the communication unit 920 transmits and receives the signals via at least one antenna 922 shown in FIG. 9. In an embodiment, the communication unit 920 may also transmit and receive the signals via physical wires/cables.

In an embodiment, the storage unit 910 and the program code 912 may be omitted. The processor 900 may include a storage unit with stored program code.

The processor 900 may implement any steps described in exemplified embodiments on the network device 90, e.g., via executing the program code 912.

The communication unit 920 may be a transceiver. The communication unit 920 may as an alternative or in addition be combining a transmitting unit and a receiving unit configured to transmit and to receive, respectively, signals to and from a communication device (e.g. a user equipment).

In some embodiments, the communication device 90 can be used to perform the operations described above (e.g., operations in the method 200, and other relevant operations). In some embodiments, the processor 900 and the communication unit 920 collaboratively perform the operations described above. For example, the processor 900 performs operations and transmit or receive signals through the communication unit 920.

In one embodiment, the processor 900 is configured for: receiving, from a communication device through the communication unit 920, a registration request corresponding to at least one piece of network slice information; and transmitting, through the communication unit 920, rejection information corresponding to the at least one piece of network slice information to the communication device, in which the rejection information comprises a rejection cause corresponding to slice incompatible information.

Details of operations of the communication device 90 can be ascertained with reference to the embodiments above, and will not be described herein.

Another aspect of the present disclosure relates to a computer program product comprising a computer-readable program medium code stored thereupon, the code, when executed by a processor, causing the processor to implement a wireless communication method recited in any of foregoing methods.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

### INDUSTRIAL APPLICABILITY

The present disclosure relates to methods, devices, and computer program products for wireless communication, which can increase the flexibility and efficiency of utilizing network slices, and extend the applicability of network slices.

1. A wireless communication method comprising:
receiving, by a communication device, rejection information corresponding to at least one piece of network slice information; and
transmitting, by the communication device, a registration request comprising a requested network slice information, wherein the requested network slice information comprises the at least one piece of network slice information corresponding to the received rejection information.

2. The wireless communication method of claim 1, wherein the at least one piece of network slice information comprises at least one piece of Single-Network Slice Selection Assistant Information (S-NSSAI) and the method further comprises:
deriving, by the communication device, at least one piece of requested network slice information for an application based on route selection rules or a local configuration; and
determining, by the communication device, whether the at least one piece of requested network slice information matches the at least one piece of network slice information corresponding to the rejection information, wherein the registration request is transmitted in response to a result of the determining.

3. The wireless communication method of claim 1, wherein the rejection information comprises a rejection cause, and the registration request is transmitted in response to the rejection cause.

4. The wireless communication method of claim 3, wherein the rejection cause comprises an indication that the at least one piece of network slice information is not supported within a wireless service area, the method further comprising:
performing, by the communication device, a cell reselection in response to the rejection cause, to select a cell outside the wireless service area, and transmitting, by the communication device, the registration request via the selected cell; and
setting, by the communication device, the at least one piece of requested network slice information in a radio access control message, to allow a radio access node to select a destination access management node supporting the at least one piece of requested network slice information,
wherein the wireless service area comprises a Registration Area.

5. The wireless communication method of claim 3, wherein the rejection cause comprises an indication that the at least one piece of network slice information is supported within a current wireless service area and not compatible with an allowed network slice information, the method further comprising:
setting, by the communication device, the at least one piece of requested network slice information in a radio access control message, to allow a radio access node to select a destination access management node supporting the at least one piece of requested network slice information.

6. The wireless communication method of claim 5, wherein:
the radio access control message does not comprise at least one piece of information relevant to a destination access management node,
the at least one piece of information relevant to a destination access management comprises at least one of 5G-S-TMSI and Globally Unique AMF ID, GUAMI, and
the requested network slice information does not comprise at least one piece of allowed network slice information.

7. A wireless communication method comprising:
receiving, by a network node from a communication device, a registration request corresponding to at least one piece of requested network slice information; and
transmitting, by the network node to the communication device, rejection information corresponding to the at least one piece of network slice information, wherein the rejection information comprises a rejection cause corresponding to slice incompatible information.

8. The wireless communication method of claim 7, wherein:
the slice incompatible information comprises an indication that the at least one piece of network slice information is not supported within the wireless service area of the communication device.

9. The wireless communication method of claim 7, wherein the slice incompatible information comprises an indication that the at least one piece of network slice information is not supported within a current Registration Area of the communication device.

10. The wireless communication method of claim 7, wherein the slice incompatible information comprises an indication that one of the at least one piece of network slice information is supported within the wireless service area of the communication device but is not compatible with an allowed network slice information.

11. The wireless communication method of claim 7, wherein the slice incompatible information comprises an indication that one of the at least one piece of network slice information is supported within a current Registration Area of the communication device but is not compatible with an allowed network slice information.

12. The wireless communication method of claim 7, wherein:
the registration request comprises a piece of Requested Network Slice Selection Assistant Information (NSSAI) and
the at least one piece of network slice information comprises at least one piece of Single-Network Slice Selection Assistant Information (S-NSSAI).

13. A communication device, comprising:
a communication unit; and
a processor configured for:
receiving, through the communication unit, rejection information corresponding to at least one piece of network slice information; and
transmitting, through the communication unit, a registration request comprising a requested network slice information, wherein the requested network slice information comprises the at least one piece of network slice information corresponding to the received rejection information.

14. The communication device of claim 13, wherein the at least one piece of network slice information comprises at least one piece of Single-Network Slice Selection Assistant Information (S-NSSAI), wherein the processor is configured for:
deriving at least one piece of requested network slice information for an application based on route selection rules or a local configuration; and
determining whether the at least one piece of requested network slice information matches the at least one piece of network slice information corresponding to the rejection information, wherein the registration request is transmitted in response to a result of the determining.

15. The communication device of claim 13, wherein:
the rejection information comprises a rejection cause, and the registration request is transmitted in response to the rejection cause,
the rejection cause comprises an indication that the at least one piece of network slice information is not supported within a wireless service area.

16. The communication device of claim 15, wherein the processor is configured for:
performing a cell reselection in response to the rejection cause, to select a cell outside the wireless service area;
transmitting, through the communication unit, the registration request via the selected cell; and
setting the at least one piece of requested network slice information in a radio access control message, to allow a radio access node to select a destination access management node supporting the at least one piece of requested network slice information.

17. The communication device of claim 15, wherein the wireless service area comprises a Registration Area.

18. The communication device of claim 14, wherein the rejection cause comprises an indication that the at least one piece of network slice information is supported within a current wireless service area and not compatible with an allowed network slice information.

19. The communication device of claim 18, wherein the processor is configured for:
setting the at least one piece of requested network slice information in a radio access control message, to allow a radio access node to select a destination access management node supporting the at least one piece of requested network slice information,
wherein the radio access control message does not comprise at least one piece of information relevant to a destination access management node,
wherein the at least one piece of information relevant to a destination access management comprises at least one of 5G-S-TMSI or Globally Unique AMF ID (GUAMI).

20. The communication device of claim 13, wherein the requested network slice information does not comprise at least one piece of allowed network slice information.
